(19) United States
(12) Patent Application Publication
(10) Pub. No.: US 2024/0388134 A1
(43) Pub. Date: Nov. 21, 2024

(54) Transmitter Device for Wirelessly Powering Receiver Devices

(71) Applicant: Huawei Digital Power Technologies Co., Ltd., Shenzhen (CN)

(72) Inventors: Fralett Suarez Sandoval, Munich (DE); Sarai Malinal Torres Delgado, Munich (DE)

(21) Appl. No.: 18/785,344

(22) Filed: Jul. 26, 2024

Related U.S. Application Data
(63) Continuation of application No. PCT/EP2022/051997, filed on Jan. 28, 2022.

(51) Int. Cl. H02J 50/12; H02J 50/40; H02J 50/80; H02J 50/90

(52) U.S. Cl. CPC H02J 50/12; H02J 50/402; H02J 50/80; H02J 50/90

(57) ABSTRACT

A transmitter device comprises a power source for providing electric power; at least one first coil electrically connected to the power source for generating a first electromagnetic field emanating from the at least one first coil; and a plurality of second coils arranged to form a three-dimensional coil array. The three-dimensional coil array is electromagnetically coupled via the first electromagnetic field to at least one first coil. The three-dimensional coil array is configured to generate a second electromagnetic field emanating from the three-dimensional coil array. The three-dimensional coil array is further configured to radiate the second electromagnetic field towards a volumetric zone for wirelessly powering at least one receiver device located in the volumetric zone.

### CROSS-REFERENCE TO RELATED APPLICATIONS

This is a continuation of International Patent Application No. PCT/EP2022/051997 filed on Jan. 28, 2022, which is hereby incorporated by reference in its entirety.

### TECHNICAL FIELD

The disclosure relates to the field of wireless power transfer or charging from transmitter structures that use resonators. In particular, the disclosure relates to a transmitter device for wirelessly powering or charging at least one receiver device, a wireless powering system and a corresponding method. The disclosure particularly relates to three-dimensional (3D) wireless power transfer with relays.

### BACKGROUND

Nowadays the number of battery-powered electronic devices is increasing rapidly because they provide freedom of movement and portability. Several methods for wireless power transmission (WPT) to recharge the battery of the electronic device without the use of a charging cable have been proposed in recent history. The major engineering challenges surrounding the wireless power transfer systems to recharge battery-powered devices can be summarized as reduced positioning freedom of the receiver device(s) because the wireless power transfer efficiency is affected by the coupling conditions of the receiver. Making this type of technology highly sensitive to lateral or angular misalignments between the transmitter and receiver devices causing that the receiver device is not properly charged or even not charged at all in some locations. Moreover, it is difficult to efficiently supply to multiple receiving devices simultaneously, to redirect the wireless power availability according to the receiver location, and to deactivate in parts the wireless power availability automatically or by user input.

Although great progress in the implementation of electromagnetic wireless power transfer has been made, there is currently no single solution that can provide efficient wireless power transmission with a high-degree of positioning freedom to the receivers, can simultaneously and efficiently supply to several receivers, can supply to receiver devices at extended transmission distances, can have the capabilities to reduce the wireless transfer of power to certain, unused locations, that is, to be able to segment the active volume, and, that can provide a more uniform magnetic field around the volume of the transmitter device.

### SUMMARY

This disclosure provides an efficient and flexible solution for a wireless power transfer with a high-degree of positioning freedom to the receivers.

The foregoing and other objects are achieved by the features of the independent claims. Further implementation forms are apparent from the dependent claims, the description and the figures.

In order to describe the disclosure in detail, the following terms and notations will be used.

In this disclosure, wireless power transfer, transmitter devices for wirelessly powering receiver devices and wireless powering systems are described.

Wireless power transfer is the transmission of electrical energy without the use of wires as a physical link. This technology uses a transmitter device capable of generating a time-varying electromagnetic field that causes a circulating electric field through a receiver device (or devices) based on the principle of electromagnetic induction. The receiver device (or devices) is (are) capable of being supplied directly from this circulating electric field or they convert it to a suitable power level to supply to an electrical load or battery connected to them.

The number of battery-powered electronic devices is increasing rapidly because they provide freedom of movement and portability. These devices should be continuously recharged to ensure they function. Their charging frequency could be diminished by the use of a large battery, but these impact the overall cost of the electronic device, as well as their weight and size.

Charging of battery-powered electronic devices is usually done with the use of a wall charger and a dedicated cable that connects to an input port of the device to be charged to establish an electrical connection between the power supply and the power-hungry device. Some disadvantages of this charging mechanism are summarized as: a) the connector at this input port is susceptible to mechanical failure due to the connection/disconnection cycles required to charge the battery, and b) each battery-powered device comes with its dedicated cable and wall charger. These two components function sometimes exclusively with each device and are not interchangeable between devices. This increases the cost of the device and the electronic-waste generated by the non-functional wall chargers and cables, c) the production of waterproof devices becomes more challenging due to the higher cost associated with the enclosure required around the input port of the battery-powered electronic device, and d) the use of a cable restricts the mobility of the user according to the length of the charging cable.

In order to avoid these disadvantages, several methods for wireless power transmission (WPT) to recharge the battery of the electronic device without the use of a charging cable have been proposed in recent history.

Commercial wireless power transfer systems have mainly been driven by two organizations, the Wireless Power Consortium and the AirFuel Alliance. The Wireless Power Consortium created the Qi Standard to wirelessly charge consumer electronic devices using magnetic induction from a base station, usually a thin mat-like object, containing one or more transmitter coils and a target device fitted with a receiving coil. Qi systems require close proximity of the transmitter and receiver devices, usually within a couple of millimeters to a couple of centimeters. Wireless power transfer systems that function under the AirFuel Alliance principle use a resonant inductive coupling between the transmitter coil and the receiver coil to consequently charge the battery connected to the receiver device. The resonant coupling allows for the power to be transferred over greater distances.

Devices, systems and methods are described to wirelessly supply to or charge the battery of electronic devices (e.g. smartphones, tablets, smart glasses, earphones, wearables, console remote controls, etc.), using wireless power transfer of the resonant type. The wireless power transfer devices described herein use magnetic resonant coupling between the resonator circuit connected to the power supply and the resonator circuits used to relay the wireless power transfer to the receiver. The wireless power transfer systems described herein use resonant inductive coupling between the transmitter resonator(s) and the receiver resonator(s). In some aspects, the wireless power transfer systems are capable of simultaneously supply to multiple receiver devices with severe angular misalignment with respect to the transmitter array and at any or many locations inside a charging volume extending outside or inside of the transmitter array. In other aspects, the methods to adjust the wireless energy transfer to the receiver device(s) are also disclosed.

According to a first aspect, the disclosure relates to a transmitter device for wirelessly powering at least one receiver device, the transmitter device comprising a power source for providing electric power, at least one first coil electrically connected to the power source for generating a first electromagnetic field emanating from the at least one first coil, and a plurality of second coils arranged to form a three-dimensional coil array, the three-dimensional coil array being electromagnetically coupled via the first electromagnetic field to the at least one first coil, the three-dimensional coil array being configured to generate a second electromagnetic field emanating from the three-dimensional coil array, wherein the three-dimensional coil array is further configured to radiate the second electromagnetic field towards a volumetric zone for wirelessly powering at least one receiver device located in the volumetric zone.

Such a transmitter device can provide efficient wireless power transmission with a high degree of positioning freedom to one or more receivers. In particular, the transmitter device is able to simultaneously and efficiently charge several receivers, to charge receiver devices at extended transmission distances, to reduce the wireless transfer of power to certain, unused locations, that is, to be able to segment the active volume. Besides, the transmitter device can provide a more uniform magnetic field around the volume of the transmitter device.

Note that wirelessly powering the receiver device can include wirelessly charging the receiver device if the receiver device has a battery. If the receiver device has no battery, it can be wirelessly powered by the transmitter device.

All of the devices described in this disclosure are not only chargers but also transmitters. This means that one can have receiver devices without a battery to charge. The idea behind the devices disclosed herein is to have a volumetric wireless power availability, i.e., the volumetric zone. This feature differentiates the disclosed devices from pad-like transmitters in which the WPT can only happen inside an area.

In an exemplary implementation of the transmitter device, the three-dimensional coil array is configured to receive the first electromagnetic field and to generate the second electromagnetic field upon the basis of the first electromagnetic field.

This provides the advantage that the second electromagnetic field can be generated upon the basis of the first second electromagnetic field. That means, by using the coupling mechanism, a single power source may be sufficient to generate both, the first and the second electromagnetic fields.

In an exemplary implementation of the transmitter device, the three-dimensional coil array is configured to generate the second electromagnetic field based on a redirection of the first electromagnetic field.

This provides the advantage that the second electromagnetic field can be flexibly directed to any direction that may be required.

In an exemplary implementation of the transmitter device, the transmitter device comprises a first capacitive element electrically connected with the at least one first coil to the power supply to form a first resonator circuit for generating the first electromagnetic field.

This provides the advantage that the resonance frequency of the first resonator circuit can be flexibly adjusted by selecting or adjusting the first capacitive element.

The electrical connection can be, for example, based on a series circuit or a parallel circuit.

In an exemplary implementation of the transmitter device, the transmitter device comprises at least one second capacitive element electrically connected with at least one second coil of the plurality of second coils to form at least one second resonator circuit for generating the second electromagnetic field.

This provides the advantage that the resonance frequency of the at least one second resonator circuit can be flexibly adjusted by selecting or adjusting the one or more second capacitive elements.

In an exemplary implementation of the transmitter device, the transmitter device comprises at least one controller configured to control an equivalent impedance of any of the coils of the at least one first coil or the three-dimensional coil array, control excitation characteristics of the at least one first coil, and/or control an electromagnetic coupling between the at least one first coil and the three-dimensional coil array.

This provides the advantage that the at least one controller can be used for performing the above control task. Thus, the transmitter device can be efficiently adjusted by controlling the above coil and coupling parameters.

There are three aspects of the device that can be controlled to perform a change. Each one can be represented by a controller or a single controller can perform the three, these are: 1) change in the equivalent impedance of any of the first or second coils. This can include changing the resonance frequency but it can also include opening or closing the electrical circuit of the resonator. 2) Change in the excitation characteristics of the power supply connected to the at least one first coil, for example, amplitude, frequency, phase. 3) Change of the electromagnetic coupling between coils. If one of these variables changes, the WPT volume will be affected and in turn the power sent to the receiver.

In an exemplary implementation of the transmitter device, the transmitter device comprises a user interface configured to initiate the control of the equivalent impedance, the control of the excitation characteristics and/or the control of the electromagnetic coupling based on a user input.

This provides the advantage that the user interface can be efficiently used for setting or controlling the characteristics of the transmitter device, e.g., controlling the coil and/or coupling parameters of the transmitter device described above and thereby adjusting the volumetric zone of the transmitter device.

In an exemplary implementation of the transmitter device, the at least one controller is configured to adjust a resonance frequency of the first resonator circuit and/or the at least one second resonator circuit based on adjusting at least one of the following: a capacitance of the first capacitive element, a capacitance of the at least one second capacitive element, an inductance of the at least one first coil, an inductance of the three-dimensional coil array.

This provides the advantage that the at least one controller can be efficiently used for adjusting the resonance frequency of the resonator circuits and hence the characteristics of the transmitter device including the volumetric WPT zone.

In an exemplary implementation of the transmitter device, the at least one first coil is arranged inside the three-dimensional coil array formed by the plurality of second coils.

This provides the advantage that the at least one first coil can be efficiently coupled to the three-dimensional coil array, since the first electromagnetic field radiate from the at least one first coil can efficiently hit the three-dimensional coil array.

In an exemplary implementation of the transmitter device, the at least one first coil is arranged in space to form a two-dimensional geometrical figure.

This provides the advantage that such implementation of the at least one first coil can be easily realized, e.g., by bending a wire in two dimensions, e.g., in the shape of a square or rectangle.

In an exemplary implementation of the transmitter device, the at least one first coil is arranged in space to form another three-dimensional coil array.

This provides the advantage that the electromagnetic coupling between the first coils and second coils can be increased.

In an exemplary implementation of the transmitter device, the electromagnetic coupling of the three-dimensional coil array via the first electromagnetic field to the at least one first coil is adjustable.

This provides the advantage that the volumetric zone can be adjusted in order to align to a location of the receiver device for optimally powering the receiver device.

In an exemplary implementation of the transmitter device, the at least one first coil is rotatable or movable arranged inside the three-dimensional coil array formed by the plurality of second coils, and/or any coil of the plurality of second coils forming the three-dimensional coil array is movable or rotatable.

This provides the advantage of a flexible and adjustable configuration of the coils resulting in a flexible volumetric zone of the transmitter device, thereby optimally powering the receiver device.

In an exemplary implementation of the transmitter device, the transmitter device is configured to adjust a rotation or movement of the at least one first coil and/or any coil of the plurality of second coils based on information of the at least one receiver device.

This provides the advantage of adjusting the intensity of the volumetric zone towards the receiver device, resulting in a more efficient powering or charging of the receiver device.

In an exemplary implementation of the transmitter device, the transmitter device comprises a receiver detection unit configured to detect at least one receiver device and to determine the information about the at least one receiver device.

This provides the advantage that the location of the receiver device can be accurately detected, and the volumetric zone can be directed towards the location of the receiver device to obtain a more efficient powering or charging of the receiver device.

The receiver detection unit can sense the receiver without any communication unit. This would mean that it is not receiving information from the receiver device. This does not exclude the possibility for having communication with the receiver. That means, in an exemplary implementation of the transmitter device, the receiver detection unit can receive information from the receiver device through a communication channel.

A receiver detection unit according to this disclosure can be an electrical and/or optical circuit for detecting a receiver device located within a proximity of the transmitter device (i.e., within the volumetric zone) or for detecting a receiver device approaching the transmitter device (i.e., approaching the volumetric zone).

In an exemplary implementation of the transmitter device, the information about the at least one receiver device comprises information about an orientation, a position and/or load changes of the at least one receiver device.

This provides the advantage that this information can be used for a precise adjustment of the volumetric zone towards the receiver device for optimally powering the receiver device.

In an exemplary implementation of the transmitter device, the coils of the transmitter device, in particular of the three-dimensional coil array, have a square, circular or polygonal geometry, in particular a two-dimensional geometrical figure, e.g., in the shape of a square, circular or polygonal geometry.

This provides the advantage that such a planar coil can be easily fabricated.

In an exemplary implementation of the transmitter device, the three-dimensional coil array has a cubical, pyramidal, polyhedral, or cylindrical arrangement.

This provides the advantage that the electromagnetic field emanating from the three-dimensional coil array is volumetric.

In an exemplary implementation of the transmitter device, at least two coils of the three-dimensional coil array are arranged adjacent to each other and positioned at an obtuse or acute angle or orthogonally or parallel with respect to each other.

This provides the advantage that different shapes for the three-dimensional coil array can be supported resulting in different geometries for the volumetric zone. Hence, an optimal powering or charging can be achieved.

According to a second aspect, the disclosure relates to a wireless powering system, comprising a transmitter device according to the first aspect, and at least one receiver device configured to receive the second electromagnetic field radiated by the transmitter device upon movement into the volumetric zone for a wireless powering.

Such a wireless powering system can provide efficient wireless power transmission with a high degree of positioning freedom to one or more receivers. In particular, the wireless powering system is able to simultaneously and efficiently charge several receivers, to charge receiver devices at extended transmission distances, to reduce the wireless transfer of power to certain, unused locations, that is, to be able to segment the active volume. Besides, the wireless powering system can provide a more uniform magnetic field around the volume of the transmitter device.

According to a third aspect, the disclosure relates to a method for radiating an electromagnetic field towards a volumetric zone for wirelessly powering at least one receiver device, the method comprising providing electric power by a power source, generating a first electromagnetic field by at least one first coil electrically connected to the power source, the first electromagnetic field emanating from the at least one first coil, generating a second electromagnetic field by a plurality of second coils arranged to form a three-dimensional coil array, the three-dimensional coil array being electromagnetically coupled via the first electromagnetic field to the at least one first coil, the second electromagnetic field emanating from the three-dimensional coil array, and radiating the second electromagnetic field by the three-dimensional coil array towards the volumetric zone for wirelessly powering the at least one receiver device.

Such a method provides the same advantages as the transmitter device according to the first aspect and the wireless powering system according to the second aspect.

According to a fourth aspect, the disclosure relates to a wireless power transmitter device comprising a power source, one or more coils electrically coupled to the power source, a 3-dimensional coil array electromagnetically coupled to the one or more coils electrically coupled to the power source and structured to produce an electromagnetic field that emanates from the 3-dimensional coil array, wherein the coils from the 3-dimensional coil array are arranged in space such that at least two coils are adjacent to each other and placed in space in a configuration selected from the group consisting of obtuse, acute, orthogonal and alternated to redirect the electromagnetic field produced by the one or more coils electrically coupled to the power source, wherein the wireless power transmitter device is operated to wirelessly power or charge an electric or electronic device by providing the produced electromagnetic field at a receiver coil or coil array to convert the received electromagnetic field into electrical energy.

In an exemplary implementation of the wireless power transmitter device, the coil(s) electrically coupled to the power source and the ones from the 3-dimensional coil array can be coils with circular or polygonal shapes such as triangular, square, rectangular, pentagonal, hexagonal, octagonal, etc.

In an exemplary implementation of the wireless power transmitter device, the coil(s) electrically coupled to the power source and the ones from the 3-dimensional coil array can be coils with different winding directions that allow a circulating current to set the pointing direction of the magnetic north pole.

In an exemplary implementation of the wireless power transmitter device, the coil(s) electrically coupled to the power source and the ones from the 3-dimensional coil array can be coils with a substrate/core of a material either with a high permeability, magnetic or composite magnetic core, or with a low permeability, e.g., a dielectric substrate like glass-reinforced epoxy laminate material (e.g., Flame Retardant 4 (FR4)).

In an exemplary implementation of the wireless power transmitter device, the coil(s) electrically coupled to the power source and the ones from the 3-dimensional coil array can be coils made of hollow conductor pipes or thin conductor films.

In an exemplary implementation of the wireless power transmitter device, the wireless power transmitter device further comprises a direct current (DC)-alternating current (AC) conversion circuit.

In an exemplary implementation of the wireless power transmitter device, the wireless power transmitter device further comprises a DC-DC conversion circuit.

In an exemplary implementation of the wireless power transmitter device, the wireless power transmitter device further comprises capacitors of fixed or variable value to create an inductive-capacitive resonant circuit.

In an exemplary implementation of the wireless power transmitter device, the wireless power transmitter device further comprises a control unit.

In an exemplary implementation of the wireless power transmitter device, the wireless power transmitter device further comprises a user interface.

According to a fifth aspect, the disclosure relates to a wireless power system comprising a wireless power transmitter device including a 3-dimensional coil array electromagnetically coupled to a power source and structured to include one or more coils electrically coupled to the power source to produce an electromagnetic field that emanates from the 3-dimensional coil array, wherein the coils from the 3-dimensional coil array are arranged in space such that at least two coils are adjacent to each other and placed in space in a configuration selected from the group consisting of obtuse, acute, orthogonal and alternated to redirect the electromagnetic field produced by the one or more coils electrically coupled to the power source to form an area in which one or more electric or electronic devices can be wirelessly powered or charged, wherein each electric or electronic device includes one or more receiver coils to receive the electromagnetic field from the 3-dimensional coil array and convert it into electrical energy.

In an exemplary implementation of the wireless power system, the power in the charging area can have a fixed or variable shape or profile.

In an exemplary implementation of the wireless power system, the wireless power system further comprises an AC-DC or DC-DC conversion circuit in the receiver device.

In an exemplary implementation of the wireless power system, the coil(s) electrically coupled to the power source and the ones from the 3-dimensional coil array can be coils with circular or polygonal shapes such as triangular, square, rectangular, pentagonal, hexagonal, octagonal, etc.

In an exemplary implementation of the wireless power system, the coil(s) electrically coupled to the power source and the ones from the 3-dimensional coil array can be coils with different winding directions that allow a circulating current to set the pointing direction of the magnetic north pole.

In an exemplary implementation of the wireless power system, the coil(s) electrically coupled to the power source and the ones from the 3-dimensional coil array can be coils with a substrate/core of a material either with a high permeability, magnetic or composite magnetic core, or with a low permeability, e.g. a dielectric substrate like glass-reinforced epoxy laminate material (e.g., FR4).

In an exemplary implementation of the wireless power system, the coil(s) electrically coupled to the power source and the ones from the 3-dimensional coil array can be coils made of hollow conductor pipes or thin conductor films.

In an exemplary implementation of the wireless power system, the wireless power system further comprises a DC-AC conversion circuit.

In an exemplary implementation of the wireless power system, the wireless power system further comprises a DC-DC conversion circuit.

In an exemplary implementation of the wireless power system, the wireless power system further comprises capacitors of fixed or variable value to create an inductive-capacitive resonant circuit.

In an exemplary implementation of the wireless power system, the wireless power system further comprises a control unit.

In an exemplary implementation of the wireless power system, the wireless power system further comprises a user interface.

According to a sixth aspect, the disclosure relates to a method for wirelessly powering or charging a device comprising providing the wireless power transmitter device according to the fourth aspect with the control unit, wherein the control unit is operated to adjust the energy transfer from the wireless power transmitter device to the device(s) to be wirelessly powered or charged by inducing a change in the equivalent impedance of the coils of the wireless power transmitter device.

In an exemplary implementation of the method, the wireless power transmitter device further comprises a receiver detection unit, wherein the control unit is operated to dynamically adjust the energy transfer from the wireless power transmitter device to the device(s) to be wirelessly powered or charged according to the information obtained by the receiver detection unit that comprises sensing the receiver orientation, position or load changes.

In an exemplary implementation of the method, the wireless power transmitter device further comprises a user interface, wherein the control unit is operated to adjust the energy transfer from the wireless power transmitter device to the device(s) to be wirelessly powered or charged depending on the input obtained by the user via the user interface.

In an exemplary implementation of the method, the wireless power transmitter device further comprises variable or fixed capacitances, wherein the variable capacitances may comprise a capacitor network, wherein the capacitor network may comprise discrete capacitors and switching elements, trimmers or digital capacitor networks, wherein the control unit sets a desired capacitance value by operating the switching network or trimmer or the digital capacitors.

In an exemplary implementation of the method, the wireless power transmitter device further comprises AC switches like solid-states-relays or transistors connected back-to-back, wherein the control unit sets a desired stated of the AC switches.

In an exemplary implementation of the method, the wireless power transmitter device further comprises a reconfigurable matching network, wherein the control unit sets a desired state of the matching network.

In an exemplary implementation of the method, the wireless power transmitter device further comprises mechanical switches, where the control unit sets a desired state of the mechanical switches.

According to a seventh aspect, the disclosure relates to a method for wirelessly powering or charging a device comprising providing the wireless power transmitter device according to the fourth aspect with the control unit, wherein the control unit is operated to change the at least one of magnitude, phase, frequency and combinations of thereof, of the electrical current flowing through the one or more coils electrically coupled to the power source, where the one or more coils are electromagnetically coupled to the 3-dimensional coil array to adjust the energy transfer from the wireless power transmitter device to the device to be wirelessly powered.

In an exemplary implementation of the method, the wireless power transmitter device further comprises a receiver detection unit, wherein the control unit is operated to dynamically adjust the energy transfer from the wireless power transmitter device to the device(s) to be wirelessly powered or charged according to the information obtained by the receiver detection unit that comprises sensing the receiver orientation, position or load changes.

In an exemplary implementation of the method, the wireless power transmitter device further comprises a user interface, wherein the control unit is operated to adjust the energy transfer from the wireless power transmitter device to the device(s) to be wirelessly powered or charged depending on the input obtained by the user via the user interface.

In an exemplary implementation of the method, the wireless power transmitter device further comprises a variable DC source, wherein the control unit sets a desired state for the DC source.

In an exemplary implementation of the method, the wireless power transmitter device further comprises a variable clock signal, wherein the control unit sets a desired state of the clock signal.

In an exemplary implementation of the method, the wireless power transmitter device further comprises a reconfigurable matching network, wherein the control unit sets a desired state of the matching network.

According to an eighth aspect, the disclosure relates to a method for wirelessly powering or charging a device comprising providing the wireless power transmitter device according to the fourth aspect with the control unit, wherein the control unit is operated to change the electromagnetic coupling between the one or more coils electrically coupled to the power source and the 3-dimensional coil array to adjust the energy transfer from the wireless power transmitter device to the device to be wirelessly powered or charged.

In an exemplary implementation of the method, the wireless power transmitter device further comprises a receiver detection unit, wherein the control unit is operated to dynamically adjust the energy transfer from the wireless power transmitter device to the device(s) to be wirelessly powered or charged according to the information obtained by the receiver detection unit that comprises sensing the receiver orientation, position or load changes.

In an exemplary implementation of the method, the wireless power transmitter device further comprises a user interface, wherein the control unit is operated to adjust the energy transfer from the wireless power transmitter device to the device(s) to be wirelessly powered or charged depending on the input obtained by the user via the user interface.

In an exemplary implementation of the method, the wireless power transmitter device further comprises a displacement control unit of the coils of the wireless power transmitter device, wherein the control unit is operated to change the XYZ location of the coils

In an exemplary implementation of the method, the wireless power transmitter device further comprises a rotation control unit of the coils of the wireless power transmitter device, wherein the control unit is operated to change the angular location of the coils

In an exemplary implementation of the method, the wireless power transmitter device further comprises coils with variable inductance, wherein the control unit is operated to change the inductance of the coils.

According to a ninth aspect, the disclosure relates to a computer program product including computer executable code or computer executable instructions that, when executed, causes at least one computer to execute the methods according to any of the preceding aspects described above.

The computer program product may run on a transmitter device as described above or on any controller or processor performing wireless power transfer.

According to a tenth aspect, the disclosure relates to a computer-readable medium, storing instructions that, when executed by a computer, cause the computer to execute the methods according to any of the preceding aspects described above. Such a computer readable medium may be a non-transient readable storage medium. The instructions stored on the computer-readable medium may be executed by a controller or a processor, e.g., by a transmitter device described above.

### BRIEF DESCRIPTION OF THE DRAWINGS

Further embodiments of the disclosure will be described with respect to the following figures.

FIG. 1 shows a schematic diagram of a wireless power transfer system according to the disclosure;

FIG. 2 shows a schematic diagram of a wireless power transfer system according to the disclosure;

FIG. 3 shows a schematic diagram illustrating different exemplary geometries, orientations and positions of the at least one first coil in relation to the three-dimensional coil array;

FIG. 4 shows a schematic diagram illustrating two examples of geometries, orientations and arrangements for devices comprising more than one first coil;

FIG. 5 shows a schematic diagram illustrating exemplary orientations of the first coil with respect to the three-dimensional coil array;

FIG. 6 shows a schematic diagram illustrating exemplary arrangements of the three-dimensional coil array in relation to the first coil;

FIG. 7 shows a schematic diagram illustrating exemplary arrangements of the three-dimensional coil array with variable equivalent impedance controlled by a switching network;

FIG. 8 shows a schematic diagram illustrating an exemplary wireless power transfer system with variable coupling between the first coil and the three-dimensional coil array;

FIG. 9 shows a schematic diagram illustrating wireless power transfer efficiency for an exemplary wireless power transfer system;

FIG. 10 shows a schematic diagram illustrating wireless power transfer efficiency for another exemplary wireless power transfer system; and

FIG. 11 shows a schematic diagram illustrating a method for wirelessly powering at least one receiver device according to the disclosure.

### DETAILED DESCRIPTION OF EMBODIMENTS

In the following detailed description, reference is made to the accompanying drawings, which form a part thereof, and in which is shown by way of illustrated aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a method step is described, a corresponding device may include a unit to perform the described method step, even if such unit is not explicitly described or illustrated in the figures. Further, it is understood that the features of the various exemplary aspects described herein may be combined with each other, unless further noted otherwise.

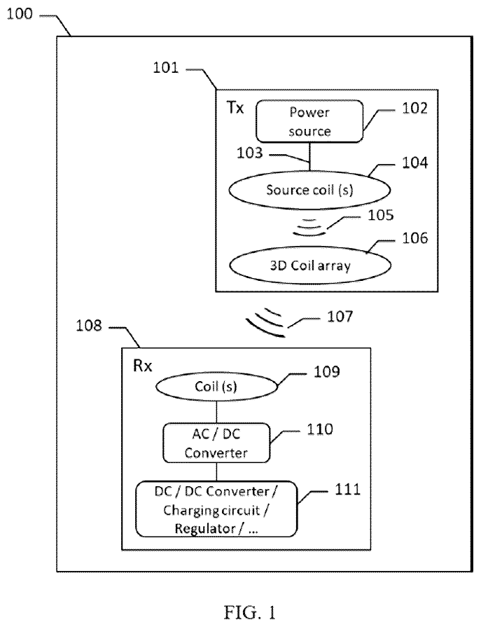

FIG. 1 shows a schematic diagram of a wireless power transfer system 100 according to the disclosure.

The wireless power transfer system 100, also called wireless powering system 100, comprises a transmitter device 101 and one or more receiver devices 108. The receiver device 108 is configured to receive an electromagnetic field 107, hereinafter referred to as a second electromagnetic field 107, radiated by the transmitter device 101 upon movement into a volumetric zone for a wireless powering of the receiver device 108. The volumetric zone specifies a volume around the transmitter device 101 in which powering of the receiver device 108 can be performed due to a sufficient strength of the second electromagnetic field 107 radiated by the transmitter device 101.

The transmitter device 101 can be used for wirelessly powering at least one receiver device 108. The transmitter device 101 comprises a power source 102 for providing electric power. The transmitter device 101 comprises at least one first coil 104, also referred to as source coil(s) hereinafter, electrically connected to the power source 102 for generating a first electromagnetic field 105 emanating from the at least one first coil 104.

The transmitter device 101 comprises a plurality of second coils arranged to form a three-dimensional coil array 106. This three-dimensional coil array 106 is electromagnetically coupled via the first electromagnetic field 105 to the at least one first coil 104. The three-dimensional coil array 106 is configured to generate a second electromagnetic field 107 emanating from the three-dimensional coil array 106.

The three-dimensional coil array 106 is further configured to radiate the second electromagnetic field 107 towards a volumetric zone for wirelessly powering at least one receiver device 108 located in the volumetric zone.

The idea behind the devices disclosed herein is to have a volumetric wireless power availability, i.e., the volumetric zone. This feature differentiates the disclosed devices from pad-like transmitters in which the WPT can only happen inside an area.

Note that all of the devices described in this disclosure are not only chargers but also transmitters. This means that one can have receiver devices 108 without a battery to charge.

The three-dimensional coil array 106 may be configured to receive the first electromagnetic field 105 and to generate the second electromagnetic field 107 upon the basis of the first electromagnetic field 105.

The three-dimensional coil array 106 may be configured to generate the second electromagnetic field 107 based on a redirection of the first electromagnetic field 105.

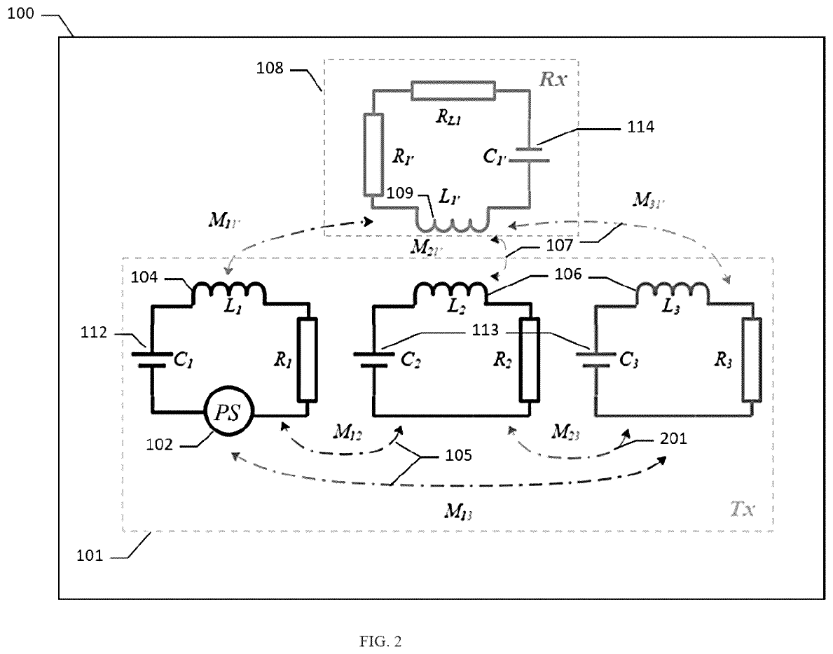

The transmitter device 101 may comprise a first capacitive element 112, as shown in FIG. 2, electrically connected with the at least one first coil 104 to the power supply 102 to form a first resonator circuit for generating the first electromagnetic field 105.

The electrical connection can be, for example, based on a series circuit or a parallel circuit.

The transmitter device 101 may comprise at least one second capacitive element 113, as shown in FIG. 2, electrically connected with at least one second coil 106 of the plurality of second coils 106 to form at least one second resonator circuit for generating the second electromagnetic field 107.

The transmitter device 101 may comprise at least one controller configured to control an equivalent impedance of any of the coils of the at least one first coil 104 or the three-dimensional coil array 106, control excitation characteristics of the at least one first coil 104, and/or control an electromagnetic coupling between the at least one first coil 104 and the three-dimensional coil array 106.

There are three aspects of the device that can be controlled to perform a change. Each one can be represented by a controller, or a single controller may perform these three aspects: Change in the equivalent impedance of any of the coils (104 or 106). This can include changing the resonance frequency, but it can also include opening or closing the electrical circuit of the resonator. Change in the excitation characteristics of the coil 104, for example, amplitude, frequency, phase. Change of the electromagnetic coupling between 104 and 106. If one of these variables changes, the WPT volume will be affected and in turn the power sent to the receiver 108.

The transmitter device 101 may comprise a user interface configured to initiate the control of the equivalent impedance, the control of the excitation characteristics and/or the control of the electromagnetic coupling based on a user input.

The at least one controller may be configured to adjust a resonance frequency of the first resonator circuit and/or the at least one second resonator circuit based on adjusting at least one of the following: a capacitance of the first capacitive element 112, a capacitance of the at least one second capacitive element 113, an inductance of the at least one first coil 104, an inductance of the three-dimensional coil array 106.

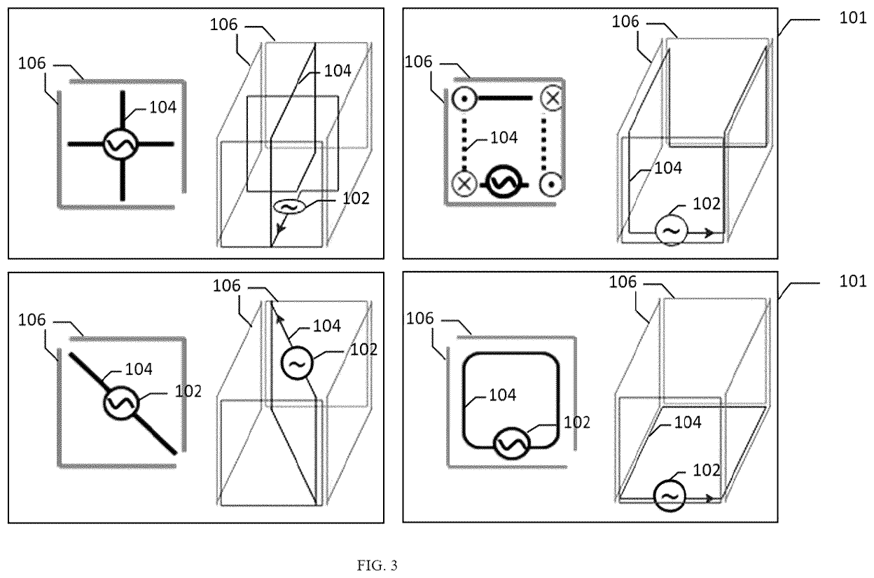

The at least one first coil 104 may be arranged inside the three-dimensional coil array 106 formed by the plurality of second coils, e.g., as shown and described below with respect to FIG. 3.

The at least one first coil 104 may be arranged in space to form a two-dimensional geometrical figure, e.g., as shown in the examples of FIG. 3.

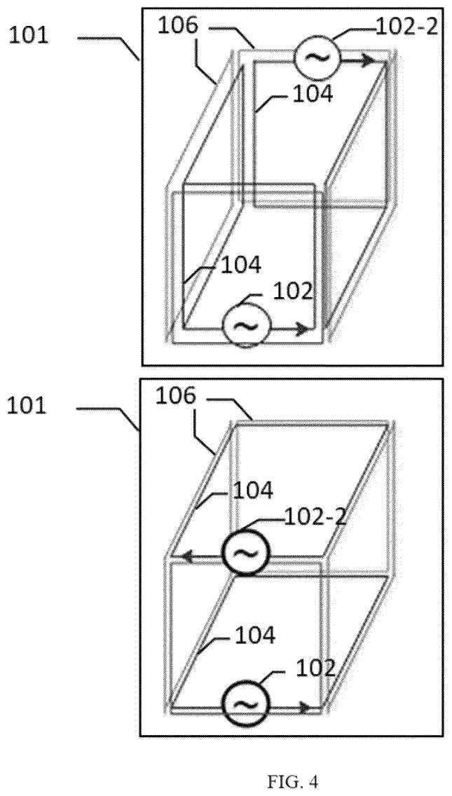

The at least one first coil 104 may be arranged in space to form another three-dimensional coil array 104, e.g., as shown in other examples of FIG. 4.

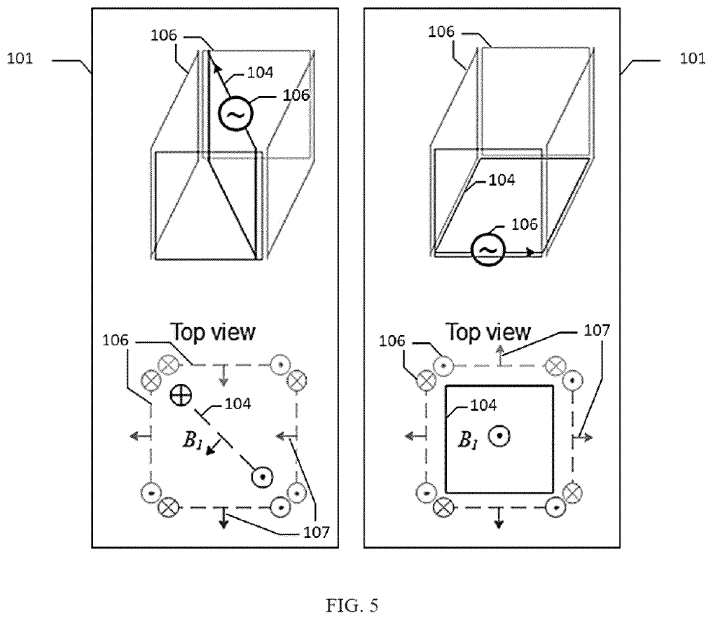

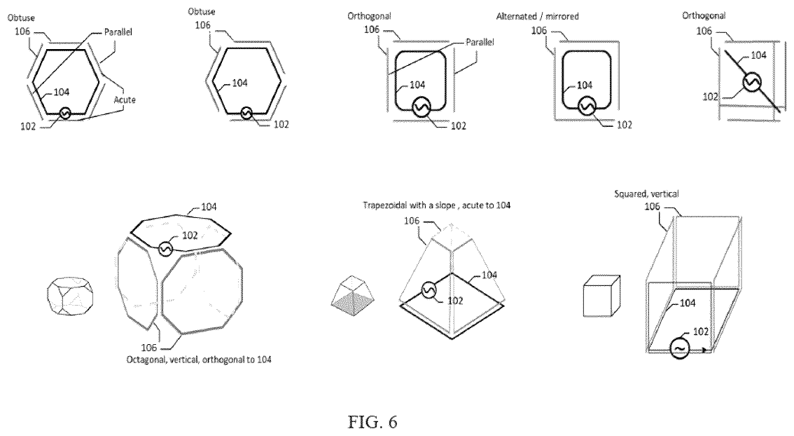

The three-dimensional coil array 106 can have a cubical, pyramidal, polyhedral, or cylindrical arrangement, e.g., as shown in FIG. 5 and FIG. 6, for example.

At least two coils of the three-dimensional coil array 106 may be arranged adjacent to each other and may be positioned at an obtuse or acute angle or orthogonally or parallel with respect to each other, e.g., as shown in FIG. 5 and FIG. 6.

The electromagnetic coupling of the three-dimensional coil array 106 via the first electromagnetic field 105 to the at least one first coil 104 is adjustable.

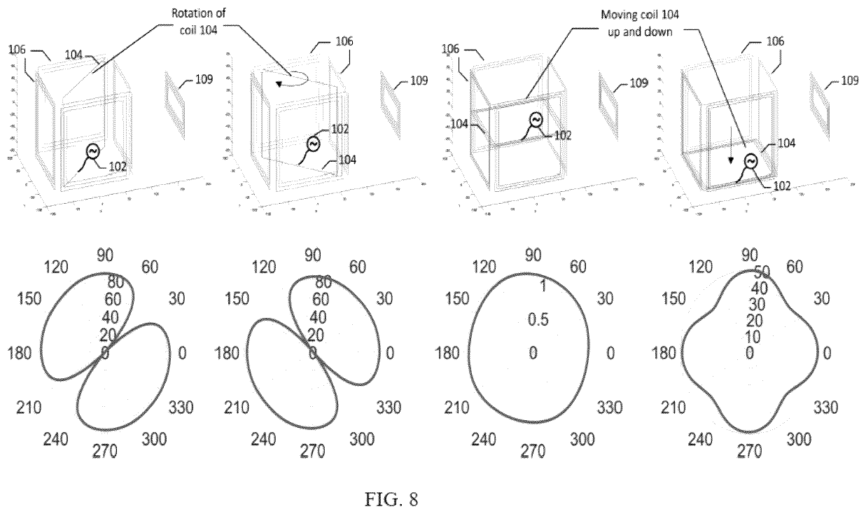

The at least one first coil 104 may be rotatable or movable arranged inside the three-dimensional coil array 106 formed by the plurality of second coils, e.g., as shown in FIG. 8. Any coil of the plurality of second coils forming the three-dimensional coil array 106 may be movable or rotatable.

The transmitter device 101 may be configured to adjust a rotation or movement of the at least one first coil 104 and/or any coil of the plurality of second coils based on information from the at least one receiver device 108.

The transmitter device 101 may further comprise a receiver detection unit configured to detect at least one receiver device 108 and to determine the information about the at least one receiver device 108.

A receiver detection unit according to this disclosure can be an electrical and/or optical circuit for detecting a receiver device located within a proximity of the transmitter device (i.e., within the volumetric zone) or for detecting a receiver device approaching the transmitter device (i.e., approaching the volumetric zone).

The information from the at least one receiver device 108 may comprise information about an orientation, a position and/or load changes of the at least one receiver device 108.

In the following, an implementation of the wireless power transfer system 100 is described.

The wireless power transfer system 100 of the technology shown in FIG. 1 is composed by a wireless power transmitter device 101 and at least one wireless power receiver device 108. The transmitter can have one or more coils 104 electrically connected 103 to a time-varying power source 102. The transmitter also comprises a 3-dimensional arrangement of coils 106 magnetically coupled 105 to the one or more coils 104 electrically coupled to the power source and structured to produce an electromagnetic field 107 that emanates from the 3-dimensional coil array 106. The coils from the 3-dimensional coil array are arranged in space such that at least two coils are adjacent to each other and placed in space in a configuration selected from the group consisting of obtuse, acute, orthogonal and alternated to redirect the electromagnetic field produced by the one or more coils electrically coupled to the power source. The wireless power transmitter device is operated to wirelessly power or charge an electric or electronic device 108 by providing the produced electromagnetic field 107 at a receiver coil or coil array 109 to convert the received electromagnetic field into electrical energy. In some embodiments, the receiver coil or coil array 109 can have the electrical energy converted from an alternating current to a direct current by an energy conversion circuit 110 to deliver the direct current to a following direct current converting circuit or to a battery charging circuit 111.

In some implementations, the power source 102 of the transmitter device 101 may be connected to the output of a DC to AC converter, in order to extract the required power for its function from a DC power source, such as a battery in the transmitter device. In some other implementations the transmitter device may also have the possibility to extract the required power for its function from an AC-DC converter, such as a circuit that converts the AC power of the line into a DC power.

The receiver device 108 can have a single coil or an arrangement of coils 109 acting to receive the wireless power coming from the transmitter device 101. In some implementations, the receiver device 108 may be connected to an AC-DC converter 110, for example a rectifier that converts the AC to a DC if the device to be powered by the specific application requires DC, such as the case of delivering DC power to an electronic device. In some other implementations, there can be a circuit 111 to convert a DC power level to another DC power level, such as a DC-DC converter or a charging circuit used to regulate the power delivered to the battery of the electronic device that is supplied to or even a voltage regulator that ensures a certain voltage level at the input of the electronic device.

FIG. 2 shows a schematic diagram of a wireless power transfer system 100 according to the disclosure.

The wireless power transfer system 100 corresponds to an implementation of the wireless power transfer system 100 described above with respect to FIG. 1.

The wireless power transfer system 100 comprises a transmitter device 101 and one or more receiver devices 108. In FIG. 2, one receiver device 108 is exemplarily shown. The receiver device 108 is configured to receive an electromagnetic field 107, also called the second electromagnetic field 107, radiated by the transmitter device 101 upon movement into a volumetric zone for a wireless powering of the receiver device 108.

The transmitter device 101 comprises a power source 102 for providing electric power. The transmitter device 101 comprises at least one first coil 104, an exemplary single first coil L1 is shown here, but it understands that more than one first coil 104 may be used. The first coil 104 is electrically connected to the power source 102 for generating a first electromagnetic field 105 emanating from the at least one first coil 104. In this example, electrically coupling is performed by a series circuit including the first coil 104 and additionally a first capacitive element C₁ and a resistive element R₁. However, any other electrical coupling can be used, e.g., by a parallel circuit, etc.

The transmitter device 101 comprises a plurality of second coils, e.g. L₂, L₃ in this example, but any other number of second coils may be used instead. The second coils are arranged to form the three-dimensional coil array 106. This three-dimensional coil array 106 is electromagnetically coupled via the first electromagnetic field 105 to the at least one first coil 104. The three-dimensional coil array 106 is configured to generate a second electromagnetic field 107 emanating from the three-dimensional coil array 106.

The three-dimensional coil array 106 is configured to radiate the second electromagnetic field 107 towards a volumetric zone for wirelessly powering the receiver device 108 located in the volumetric zone.

As described above with respect to FIG. 1, the transmitter device 101 may comprise a first capacitive element 112 electrically connected with the at least one first coil 104 to the power supply 102 to form a first resonator circuit for generating the first electromagnetic field 105. As described above, the electrical connection can be, for example, based on a series circuit or a parallel circuit.

The transmitter device 101 may comprise at least one second capacitive element 113 electrically connected with at least one second coil 106 of the plurality of second coils 106 to form at least one second resonator circuit for generating the second electromagnetic field 107.

In some embodiments of the presented technology, the transmitter device 101 can include inductive-capacitive resonator circuits in the coil electrically coupled to the power supply 102 by the addition of a capacitive element 112 or in the coils electromagnetically coupled 106 to the coil connected to the power supply by the addition of the capacitive elements 113 as depicted in FIG. 2. The coils from the 3-dimensional coil array may present a mutual inductance 201 as illustrated in FIG. 2.

FIG. 3 shows a schematic diagram illustrating different exemplary geometries, orientations and positions of the at least one first coil 104 in relation to the three-dimensional coil array 106. Thus, FIG. 3 illustrates different exemplary implementations of the transmitter device 101 described above with respect to FIG. 1 and FIG. 2.

Different geometries, orientations, and positions of the coil 104 electrically connected to the power supply 102 are shown in the manner of examples to demonstrate several embodiments of the device of this disclosure.

From left to right and top to bottom: the coil electrically coupled to the power supply can be, for instance, a single continuous cross-like coil or also known as single-phase coil for rotating magnetic field generation, a coil winded as one of the coils of a multi-phase rotating magnetic field machine, a planar vertical coil, planar horizontal coil or many other not depicted in FIG. 3, such as Helmholtz coils, solenoidal coils, etc. Depending on the position, orientation and direction of winding, the electromagnetic field 107 that emanates from the 3-dimensional coil array 106 may vary as shown in FIG. 5.

FIG. 4 shows a schematic diagram illustrating two examples of geometries, orientations and arrangements for devices comprising more than one first coil 104. Thus, FIG. 4 illustrates different exemplary implementations of the transmitter device 101 described above with respect to FIG. 1 and FIG. 2.

In FIG. 4, two examples of geometries, orientations and arrangements for devices comprising more than one coil 104 electrically coupled to the power sources 102 and 102-2 are depicted. From top to bottom: these may be for instance 2 double-spiral coils or any other geometry of alternated coils that face each other, or two planar or any other geometry of parallel coils vertically or horizontally placed.

FIG. 5 shows a schematic diagram illustrating exemplary orientations of the first coil 104 with respect to the three-dimensional coil array 106. Thus, FIG. 5 illustrates different exemplary implementations of the transmitter device 101 described above with respect to FIG. 1 and FIG. 2.

FIG. 5 depicts two different orientations of the coil 104 electrically connected to the power supply 102 magnetically coupled to the same 3D arrangement of coils 106 to exemplify how the change in the position, orientation and direction of winding can change the electromagnetic field 107 that emanates from the 3-dimensional coil array 106.

If for instance, the coil 104 in the second example is placed on the top layer instead of at the bottom, and everything else is kept constant, the electromagnetic field 107 that emanates from the 3-dimensional coil array 106 will point inwards. The same will happen if the coil 104 is kept in the bottom plane but the direction of the current flow is then inversed.

FIG. 6 shows a schematic diagram illustrating exemplary arrangements of the three-dimensional coil array 106 in relation to the first coil 104. FIG. 6 illustrates different exemplary implementations of the transmitter device 101 described above with respect to FIG. 1 and FIG. 2.

In FIG. 6 examples of the 3-dimensional coil arrangements 106 electromagnetically coupled 105 to the coil(s) 104 electrically coupled to the power source 102 are shown, wherein at least two of the coils of the 3-dimensional array 106 are arranged in space such that at least two coils are adjacent to each other and placed in space in a configuration selected from the group consisting of obtuse, acute, orthogonal and alternated (non-parallel) coils. FIG. 6 also shows exemplary geometries, orientations, and positions of the coils composing the 3-dimensional coil array 106. Geometries may, for example, include but are not limited to square, circle, polygons, trapezoids arrangements. Moreover, the coils from the 3-dimensional coil array 106 can be placed acute, obtuse, orthogonal or even parallel to the coil(s) 104 electrically coupled to the power source 102.

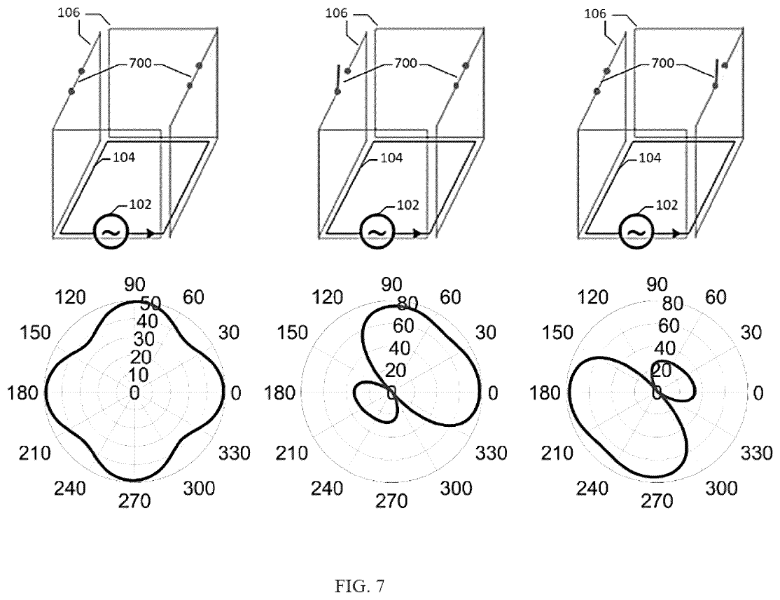

FIG. 7 shows a schematic diagram illustrating exemplary arrangements of the three-dimensional coil array 106 with variable equivalent impedance controlled by a switching network. FIG. 7 thus illustrates different exemplary implementations of the transmitter device 101 described above with respect to FIG. 1 and FIG. 2.

FIG. 7 depicts some embodiments in which the disclosed wireless power transmitter device 101 can adjust the energy transfer from it to the receiver device 108 by inducting a change in the equivalent impedance of the coils composing the 3-dimensional coil array 106. This change in impedance can be performed by a matching network 700, e.g., AC switches such as transistors back-to back, SSR, or mechanical switches.

Additionally, FIG. 7 also shows the wireless power transfer efficiency expected from the exemplified transmitter topology in three different operating states for a rotational sweep of a receiver device 108 configured to receive the wireless energy being sent from the transmitter device that scans the profile of the available wireless power around the transmitter 101.

The three exemplified configurations involve the change in the equivalent impedance of the coils in the 3-dimensional array 106 by opening and closing a switch connected in series with each of the coils. A similar equivalent impedance adjustment can be performed on the coil electrically coupled 104 to the power supply 102.

FIG. 8 shows a schematic diagram illustrating an exemplary wireless power transfer system with variable coupling between the first coil 104 and the three-dimensional coil array 106. FIG. 8 thus illustrates different exemplary implementations of the wireless power transfer system 100 described above with respect to FIG. 1 and FIG. 2.

Some embodiments are depicted in which the disclosed wireless power transmitter device 101 can adjust the energy transfer from it to the receiver device 108 by changing the electromagnetic coupling 105 between the coil(s) 104 electrically coupled to the power supply 102 and the 3-dimensional coil array 106.

The change of the electromagnetic coupling 105 can by induced by but it is not limited to, rotating the coil 104 electrically connected to the power source 102, or moving it up or down.

FIG. 8 also depicts the wireless power transfer efficiency expected between the exemplified wireless power transmitter device 101 and a receiver device 109 configured to receive the wireless energy being sent from the transmitter device that scans the profile of the available wireless power around the transmitter in a rotation sweep as to demonstrate the induced change in the energy transfer.

The receiver device 109 may correspond to the receiver device 108 described above with respect to FIG. 1 and FIG. 2.

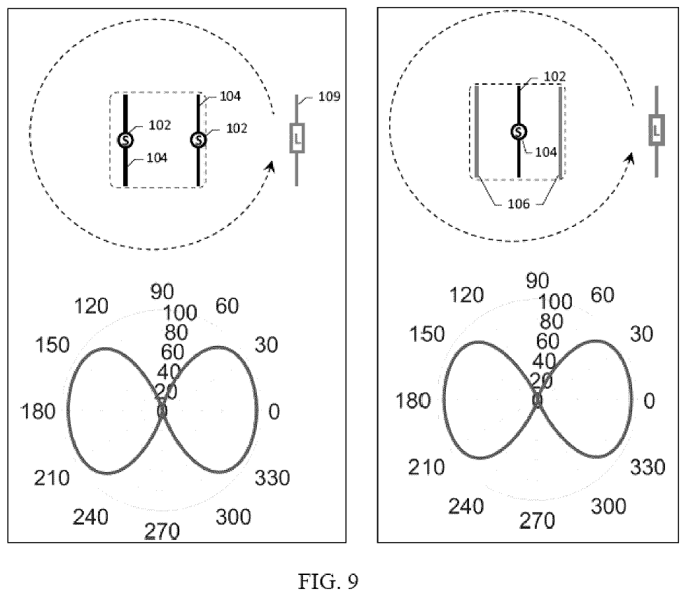

The disclosed transmitter device may have the ability to present an electromagnetic field that emanates from the 3-dimensional coil array while creating a wireless power transfer profile around it by the use of even a single power supply and additional relay resonators as shown on the right part of FIG. 9. This is a benefit over wireless power transfer in which every coil in the transmitter structure has its own power supply as shown on the left part of FIG. 9. The creation of a wireless power transfer area around the transmitter device permits the disclosed technology to be able to transmit wireless power to receiver device(s) with differing coupling conditions coming from different positions or orientations of the receiver coil(s) on the receiver devices even when no methods to adjust the energy transfer to the receiver(s) are applied. The presented transmitter device can supply to multiple receivers simultaneously due to its magnetic field homogenization capabilities.

FIG. 9 shows a schematic diagram illustrating wireless power transfer efficiency for two exemplary wireless power transfer systems, one that does not use relay resonators (left box on FIG. 9) and one with the use of relay resonators (right box on FIG. 9) according to the disclosure. In particular, FIG. 9 shows a comparison of the wireless power transfer efficiency expected from two wireless power transmitter devices for a rotational sweep of a receiver device 109.

FIG. 9 thus illustrates an exemplary implementation of the wireless power transfer system 100 described above with respect to FIG. 1 and FIG. 2.

The receiver device 109 may correspond to the receiver device 108 described above with respect to FIG. 1 and FIG. 2.

The receiver device 109 is configured to receive the wireless energy being sent from the transmitter device that scans the profile of the available wireless power around the transmitter.

One of the wireless power transmitter devices shown on the left-hand side of FIG. 9 may have two parallel coils, each one electrically coupled to a power supply. The second of the wireless power transmitter devices shown on the right-hand side of FIG. 9 may have two parallel equidistant coils 106 electromagnetically coupled 105 to one coil 104 electrically coupled to the power source 102.

Both efficiency profiles look very similar with a slightly reduced efficiency for the second analyzed wireless power transfer device (on the right-hand side of FIG. 9), however, being able to reduce the power supplies from two to only one with the implementation of relay resonators may decrease the system complexity.

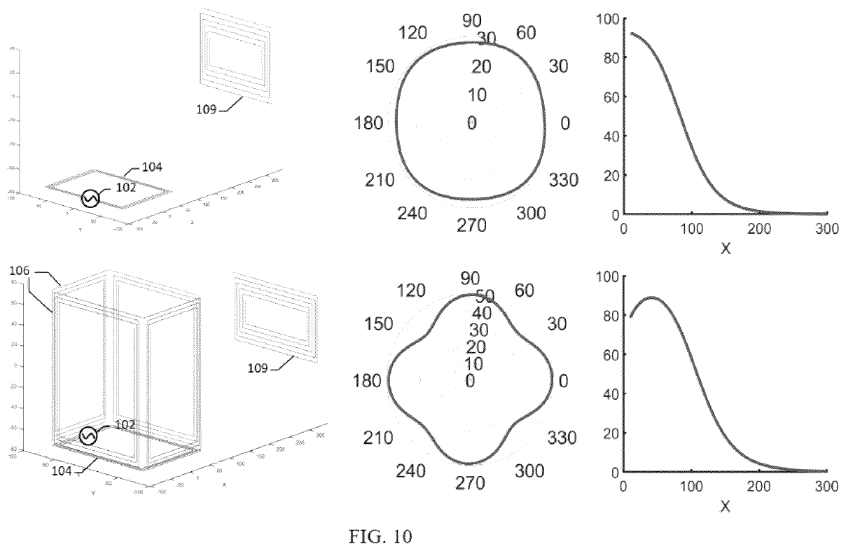

FIG. 10 shows a schematic diagram illustrating wireless power transfer efficiency for another exemplary wireless power transfer system. FIG. 10 thus illustrates different exemplary implementations of the wireless power transfer system 100 described above with respect to FIG. 1 and FIG. 2.

FIG. 10 shows a comparison of the wireless power transfer efficiency expected from two wireless power transmitter devices for a linear and a rotational sweep of a receiver device 109.

The receiver device 109 may correspond to the receiver device 108 described above with respect to FIG. 1 and FIG. 2.

The receiver device 109 is configured to receive the wireless energy being sent from the transmitter device that scans the profile of the available wireless power around the transmitter.

One of the wireless power transmitter devices shown on top of FIG. 10 has one planar and horizontal coil 104 connected to a power supply 102.

The second wireless power transmitter device shown on bottom of FIG. 10 has two alternated double-spiral coils 106 facing each other that are orthogonal and electromagnetically coupled 105 to one planar and horizontal coil 104 electrically coupled to the power source 102.

Without any of the control methods for adjusting the wireless power transfer to the receiver, the presence of the 3-dimensional array electromagnetically coupled to the coil electrically coupled to the power supply can increase the wireless power transfer efficiency as can be seen from the right-hand side diagrams depicted in FIG. 10.

The disclosed systems and methods allow to adjust the energy transfer to the receiver device(s) in order to avoid that energy is sent to omni-directionally, when there is only one receiver or a group of receiver devices located at the same zone around the transmitter array or to adjust the amount of wireless energy transfer that the receiver device(s) is receiving at any given time as shown in FIG. 7.

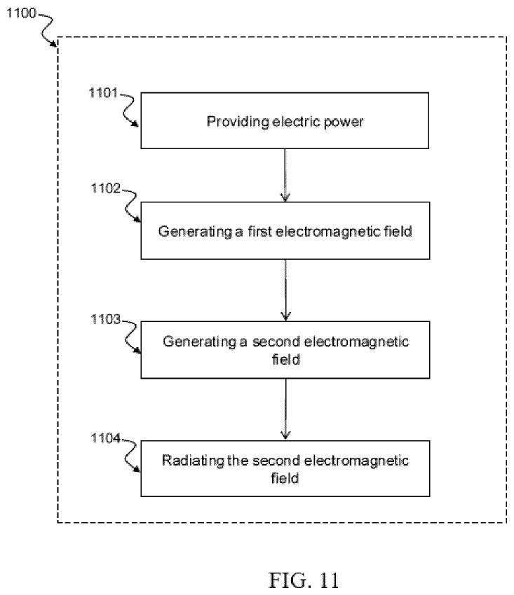

FIG. 11 shows a schematic diagram illustrating a method 1100 for wirelessly powering at least one receiver device according to the disclosure.

The method 1100 may be performed by a transmitter device 101 as described above with respect to FIG. 1 to FIG. 10.

The method 1100 may be performed for radiating an electromagnetic field towards a volumetric zone, e.g., of a transmitter device 101 as described above with respect to FIG. 1 to FIG. 10, for wirelessly powering at least one receiver device 108, e.g. a receiver device 108 shown in FIG. 1 or FIG. 2 or a receiver device 109 shown in FIG. 8 to FIG. 10.

The method 1100 comprises step 1101 providing electric power by a power source 102, e.g., as described above with respect to FIG. 1 to FIG. 10.

The method 1100 comprises step 1102 generating a first electromagnetic field 105 by at least one first coil 104 electrically connected to the power source 102, the first electromagnetic field 105 emanating from the at least one first coil 104, e.g., as described above with respect to FIG. 1 to FIG. 10.

The method 1100 comprises step 1103 generating a second electromagnetic field 107 by a plurality of second coils arranged to form a three-dimensional coil array 106, the three-dimensional coil array 106 being electromagnetically coupled via the first electromagnetic field 105 to the at least one first coil 104, the second electromagnetic field 107 emanating from the three-dimensional coil array 106, e.g., as described above with respect to FIG. 1 to FIG. 10.

The method 1100 comprises step 1104 radiating the second electromagnetic field 107 by the three-dimensional coil array 106 towards the volumetric zone for wirelessly powering the at least one receiver device 108, e.g., as described above with respect to FIG. 1 to FIG. 10.

As described above with respect to FIG. 1 to FIG. 9, the wireless power transmitter device 101 may comprise a user interface. The wireless power transmitter device 101 can be operated by the user and a control unit to wirelessly power or charge electric or electronic device(s) by reconfiguring the wireless power transfer profile.

For example, such a user interface may include a press-button, a mechanical switch whose actuator is in reach of the user and/or a manual selection of an operation mode of the transmitter device 101 on a touch display located onto the transmitter device 101 or activated wirelessly by information obtained via electromagnetic waves between a wireless communication stage of the receiver device 108 and the transmitter device 101.

The information obtained by the user may over-ride the currently active operation mode of the transmitter device 101 or the information coming from a receiver detection unit.

As described above with respect to FIG. 1 to FIG. 9, the wireless power transmitter device 101 may comprise a receiver detection unit.

Such a receiver detection unit may detect at least one receiver device 108 located inside the volumetric zone. For example, the following procedure may be applied for detection:
1) Starting operation of the wireless power transmitter device 101.
2) If a receiver device 108 configured to receive the wireless power from the wireless power transmitter device 101 is detected by the receiver detection unit, the following items may be performed:
3) The control unit of the transmitter device 101 assesses if the at least one receiver device 108 is inside the volumetric zone, i.e., the volume in which the wireless power transmitter device 101 can supply wireless power to the receiver device 108.
3a) When supplying wireless power is possible, the control unit instructs the wireless power transmitter device 101 to initiate a wireless power transfer protocol to the receiver device 108 and may additionally inform the user about the active wireless power transfer volume around the transmitter device 101.
3b) When supplying wireless power is not possible, the control unit may indicate the user that no power supply is possible, e.g., by using a visualization unit to call for the user's attention by, for instance, performing light blinking or dimming effects to inform the user about the active wireless power transfer volume around the transmitter device in which the transmitter device 101 is capable of providing wireless power to the receiver device 108.
4) While the transmitter device 101 is active, the above loop, i.e., items 2), 3), 3a) and 3b) may be repeated.

This procedure may also assess if the current condition is the same as the condition from the last cycle to avoid turning on and off the wireless power supply 102 continuously or keep informing the user about the active wireless power transfer volume around the transmitter device in which the transmitter device 101 is capable of providing wireless power to the receiver device 108.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as described herein.

1. A transmitter device comprising:
a power source configured to provide electric power;
at least one first coil electrically coupled to the power source and configured to generate, using the electric power, a first electromagnetic field that emanates from the at least one first; and
second coils arranged to form a three-dimensional coil array, wherein one of the second coils is movable, wherein the three-dimensional coil array is electromagnetically coupled via the first electromagnetic field to the at least one first coil, (and wherein the three-dimensional coil array is configured to:
generate a second electromagnetic field that emanates from the three-dimensional coil array; and
radiate the second electromagnetic field towards a volumetric zone for wirelessly powering at least one receiver device located in the volumetric zone.

2. The transmitter device of claim 1, wherein the three-dimensional coil array is further configured to;
receive the first electromagnetic field; and
further generate the second electromagnetic field based on the first electromagnetic field.

3. The transmitter device of claim 1, wherein the three-dimensional coil array is further configured to further generate the second electromagnetic field by redirecting the first electromagnetic field.

4. The transmitter device of claim 1, further comprising a first capacitive element electrically coupled to the at least one first coil to and the power source to form a first resonator circuit that generates the first electromagnetic field.

5. The transmitter device of claim 4, further comprising at least one second capacitive element electrically coupled to at least one second coil of the plurality of second coils to form at least one second resonator circuit that generates the second electromagnetic field.

6. The transmitter device of claim 5, wherein the at least one first coil comprises a first equivalent impedance, wherein the three-dimensional coil array comprises a second equivalent impedance, and wherein the transmitter device further comprises at least one controller configured to:
control the first equivalent impedance or the second equivalent impedance;
control excitation characteristics of the at least one first coil; or
control an electromagnetic coupling between the at least one first coil and the three-dimensional coil array.

7. The transmitter device of claim 6, further comprising a user interface configured to control, based on a user input, the first equivalent impedance or the second equivalent impedance, the excitation, or the electromagnetic coupling.

8. The transmitter device of claim 6, wherein the first resonator circuit comprises a first resonance frequency, wherein the at least one second resonator circuit comprises a second resonance frequency, and wherein the at least one controller is further configured to adjust the first resonance frequency or the second resonance frequency by adjusting at least one of the following:
a first capacitance of the first capacitive element;
a second capacitance of the at least one second capacitive element;
an inductance a first inductance of the at least one first coil; or
a second inductance of the three-dimensional coil array.

9. The transmitter device of claim 1, wherein the at least one first coil is arranged inside the three-dimensional coil array.

10. The transmitter device of claim 1, wherein the at least one first coil is arranged in a space to form a two-dimensional geometrical figure.

11. The transmitter device of claim 1, wherein the at least one first coil is arranged in a space to form a second three-dimensional coil array.

12. The transmitter device of claim 1, wherein the three-dimensional coil array is configured to be adjustably and electromagnetically coupled via the first electromagnetic field to the at least one first coil.

13. The transmitter device of claim 1, wherein the at least one first coil is configured to be arranged inside the three-dimensional coil array; or wherein one of the second coils is configured to be rotatable.

14. The transmitter device of claim 13, further comprising at least one controller and configured to:
receive first information from the at least one receiver device; and
adjust a rotation or a movement of the at least one first coil or the one of the second coils based on the first information.

15. The transmitter device of claim 14, further comprising a receiver detector configured to:
detect the at least one receiver device; and
obtain the first information based on detecting the at least one receiver device.

16. The transmitter device of claim 14, wherein the first information comprises second information about an orientation, a position of the at least one receiver device, or load changes of the at least one receiver device.

17. The transmitter device of claim 1, wherein each of the at least one first coil and the second coils has a square geometry, a circular geometry, or a polygonal geometry.

18. The transmitter device of claim 1, wherein the three-dimensional coil array has a cubical arrangement, a pyramidal arrangement, a polyhedral arrangement, or a cylindrical arrangement.

19. The transmitter device of claim 1, wherein at least two coils of the three-dimensional coil array are arranged adjacent to each other and positioned at an obtuse angle with respect to each other, an acute angle with respect to each other, orthogonally with respect to each other, or parallel with respect to each other.

20. A wireless powering system, comprising:
a transmitter device comprising:
a power source configured to provide electric power;
at least one first coil electrically coupled to the power source and configured to generate a first electromagnetic field that emanates from the at least one first coil; and
second coils arranged to form a three-dimensional coil array, wherein the three-dimensional coil array is electromagnetically coupled via the first electromagnetic field to the at least one first coil is configured to;
generate a second electromagnetic field emanating that emanates from the three-dimensional coil array; and
radiate the second electromagnetic field-towards a volumetric zone; and
at least one receiver device wirelessly coupled to the transmitter device and configured to:
move into the volumetric zone; and
receive, from the transmitter device and upon moving into the volumetric zone, the second electromagnetic field for a wireless powering.
